(19) United States
(12) Patent Application Publication
(10) Pub. No.: US 2011/0153035 A1
(43) Pub. Date: Jun. 23, 2011

(54) Sensor Failure Detection System And Method

(75) Inventors: Anthony J. Grichnik, Peoria, IL (US); Timothy J. Felty, Peoria, IL (US); Tyler J. Tippett, East Peoria, IL (US); James R. Mason, Peoria, IL (US); Brandon P. Zobrist, Peoria, IL (US)

(73) Assignee: Caterpillar Inc., Peoria, IL (US)

(21) Appl. No.: 12/644,497

(22) Filed: Dec. 22, 2009

(51) Int. Cl. G05B 13/02

(52) U.S. Cl. 700/21; 700/33

(57) ABSTRACT

This disclosure relates to a system and method for detecting sensor failure and controlling a machine. The system includes a plurality of physical sensors, an electronic control module operably connected to the plurality of physical sensors, and a data storage unit operably connected to the electronic control module. The electronic control module is configured to retrieve calibration data associated with a plurality of input parameters, obtain a set of values of the plurality of input parameters, calculate a Mahalanobis distance of the set of values of the input parameters based on the calibration data, increment an evidence score of an input parameter if the Mahalanobis distance exceeds a threshold Mahalanobis distance value; and command a machine action when the evidence score of an input parameter exceeds an threshold evidence score value.

### TECHNICAL FIELD

This disclosure relates generally to a system and method for controlling a machine in the event of sensor failure. More specifically, the system detects when a sensor has failed but the sensor is still returning values that are within the expected range of values for the sensor.

### BACKGROUND

Engines, automobiles, earth-moving machines, aircraft, and myriad other types of machines contain a number of physical sensors to determine the status of various machine components and/or the state of the machine itself. Physical sensors may take measurements of physical phenomena or conditions and provide data for use by machine control systems. For example, on an earth-moving machine, sensors detect a number of conditions. A non-exclusive list of examples includes: machine speed, engine speed, engine temperature, exhaust emissions (e.g., NOx), hydraulic pressure, and position of implements/work tools.

Increasingly, machines are employing advanced hardware and/or software control systems to optimize operation. These control systems employ logic systems based on one or more measured parameters relating to the state of the machine and/or one or more of the machine's component systems. For example, complex exhaust after-treatment systems are being developed for diesel engines to mitigate or eliminate environmental emissions while still retaining acceptable engine performance and fuel consumption. Control of the after-treatment system may rely at least in part on the accuracy of one or more physical sensors that measure parameters relating to the operation of the engine.

Consequently, as more sophisticated machine control systems are developed that rely on data from physical sensors, it is increasingly important to know whether the sensors supplying the underlying data are delivering accurate data. If the data on which the control system relies is in-accurate, the control system may fail and/or cause machine systems to fail. This might result in reduced machine performance and possibly the inoperability of the machine itself. For example, the failure of a timing sensor on an engine may render the engine system inoperable even if the other components in the engine system remain operable.

Thus, in many machine systems, it is increasingly important to detect when a sensor has failed. In some circumstances failure detection is relatively easy, such as when the sensor begins to supply data that is outside of the range of expected data values for the sensor. For example, if a sensor that is supposed to return a voltage in the range of 5V to 15V begins to return a value of 2V, one might suspect or determine that the sensor has failed.

In other circumstances, however, it is more difficult to determine when a sensor has failed. For example, a sensor might supply values that are still within in the theoretical range of expected values, but are nonetheless inaccurate. Sometimes this condition is called a “soft failure” of the sensor. For some sensors, soft failure is a common mode of failure. This type of failure, however, is more difficult to detect, because one cannot simply look at whether the sensor is returning data that is within the boundary of expected values. Instead, one must look more quantitatively at the nature of the data and attempt to detect a trend or pattern that may indicate that the sensor has failed soft.

The challenge of detecting a trend or pattern in sensor data, however, lies in that the analysis may require considerable data (necessitating significant data storage capacity) and/or significant computational power to detect a soft failure of a sensor. This may require significant time to acquire the necessary data and to perform the necessary data analysis before detecting the soft failure. In many circumstances, however, there may be limitations on the data storage capacity and computational capacity available to perform data analysis to detect sensor failure. In these circumstances it is desirable to have a system which can detect the failure of one or more sensors (including soft failures) but that can do so quickly and without consuming significant computational and/or data storage resources.

U.S. Pat. No. 6,782,348 to Ushiku (“Ushiku”) relates to a diagnostic apparatus for detecting failure in equipment. Ushiku describes a diagnostic process to reduce false alarms that are reporting valid values in situations where the process to be monitored is more reliable than the sensors used to monitor it. In Ushiku, systems are shut down unnecessarily because of such errors. The method disclosed in Ushiku requires continuous monitoring of all signals at all times, which drives high computing costs and complexity. Additionally, computing complexity is increased factorally by continuously recalculating all possible combinations of monitored signals as well. Ushiku does not address the possibility of multiple simultaneous sensor failures, nor the possibility that such failures may occur intermittently over time.

The present disclosure is directed to overcoming or mitigating one or more of the problems set forth above.

### SUMMARY

In one aspect of the disclosure, a method for controlling a machine is disclosed. The method includes the step of retrieving calibration data associated with a plurality of input parameters. At least one of the plurality of input parameters represents data from a physical sensor on the machine. The method also includes the steps of obtaining a set of values of the plurality of input parameters and calculating a Mahalanobis distance of a set of values of the input parameters based on the calibration data. The method includes the further steps of incrementing an evidence score of an input parameter if the Mahalanobis distance exceeds a threshold Mahalanobis distance value, and commanding a machine action when the evidence score of an input parameter exceeds a threshold evidence score value.

In another aspect, a system for detecting a sensor failure is disclosed. The system includes a plurality of physical sensors, an electronic control module operably connected to the plurality of physical sensors, and a data storage unit operably connected to the electronic control module. The electronic control module is configured to retrieve calibration data associated with a plurality of input parameters, obtain a set of values of the plurality of input parameters, calculate a Mahalanobis distance of the set or subset of values of the input parameters based on the calibration data, increment an evidence score of an input parameter if the Mahalanobis distance exceeds a threshold Mahalanobis distance value; and command a machine action when the evidence score of an input parameter exceeds an threshold evidence score value.

### BRIEF DESCRIPTION OF THE DRAWINGS

FIG. 1 shows an exemplary machine incorporating a sensor failure detection system.

FIG. 2 illustrates a block diagram of the components of a control system consistent with the present disclosure.

FIG. 3 shows an exemplary set of vectors representing a plurality of sensor parameters.

FIG. 4 shows a flowchart of an exemplary method for sensor failure detection in accordance with the disclosure.

FIG. 5 shows a flowchart of an exemplary method to check for the failure of an individual sensor.

FIG. 6 shows an exemplary set of vectors representing a plurality of sensor parameters.

### DETAILED DESCRIPTION

FIG. 1 shows an exemplary machine 100 incorporating features consistent with the present disclosure. Machine 100 may be a fixed or mobile machine that performs some type of operation and that includes at least one physical sensor. Machine 100 in FIG. 1 is depicted as an earth-moving machine, and other examples in this disclosure use an earth-moving machine for instructive purposes. However, myriad other types of machines may use the systems and methods described herein. A non-exclusive list of such machines includes: automobiles, trucks, construction equipment, mining vehicles, material handlers, farming equipment, aircraft, marine vessels, power generation equipment, turbines, manufacturing equipment and tooling, facility and building management systems, computer systems, and communication systems.

As shown in FIG. 1, machine 100 may include an engine 110, an electronic control module (or “ECM”) 120, a communications interface 130, physical sensors 140 and 142, and a data link 150. Engine 110 can be an internal combustion engine, generator, fuel cell, or other propulsion means. Electronic control module 120 may include any number of devices necessary to perform logic, communication, and/or control functions on the machine. Exemplary components of electronic control module 120 include: microprocessors, input/output devices, memory, data storage devices, etc. Electronic control module 120 may also include software and/or hardware coded instructions for performing functions necessary to the operation of machine 100.

In addition, electronic control module 120 may control other aspects of the operation of machine 100 (e.g. transmission control, hydraulic control, etc.) in addition to performing functions related to the control system of the present disclosure. Likewise, machine 100 may include a plurality of electronic control modules that together provide the control functions required for machine 100. The number of electronic control modules and their particular system architecture will vary with the needs of the particular machine, as one of skill in the art will recognize, and can be appropriately combined with the control systems and methods of this disclosure.

Electronic control module 120 is operably coupled to data link 150 to send and receive data to or from other components of machine 100. This may include communications interface 130, physical sensor 140, physical sensor 142, and other components not shown. Data link 150 may comprise typical data transmission media such as wired, wireless, and/or optical communication connections.

In the example of FIG. 1, physical sensors 140 and/or 142 are operably connected to engine 110. Physical sensor 142 may sense parameters related to the operation and state of engine 110 and its related components. For example, physical sensor 142 might measure temperature, pressure, a valve position, airflow, liquid flow, emissions (e.g., NO_{R}, CO₂, etc.), chemical composition, or any other physical condition or state. Physical sensor 142 might also measure the quantity or nature of an electrical or electromagnetic signal (e.g., a radio frequency).

Machine 100 optionally includes a communications interface 130 for sending and receiving data to or from machine 100 and other machines or devices. Communications interface 130 might be a network device, wired or wireless communications device, and/or a data port for manual or automatic transmission of data. It is not required, however, to send data to or from machine 100 in order to practice the systems and methods disclosed herein, as embodiments of the present disclosure are amenable to performance entirely onboard machine 100, or alternatively, using a data connection to one or more electronic control modules not onboard machine 100.

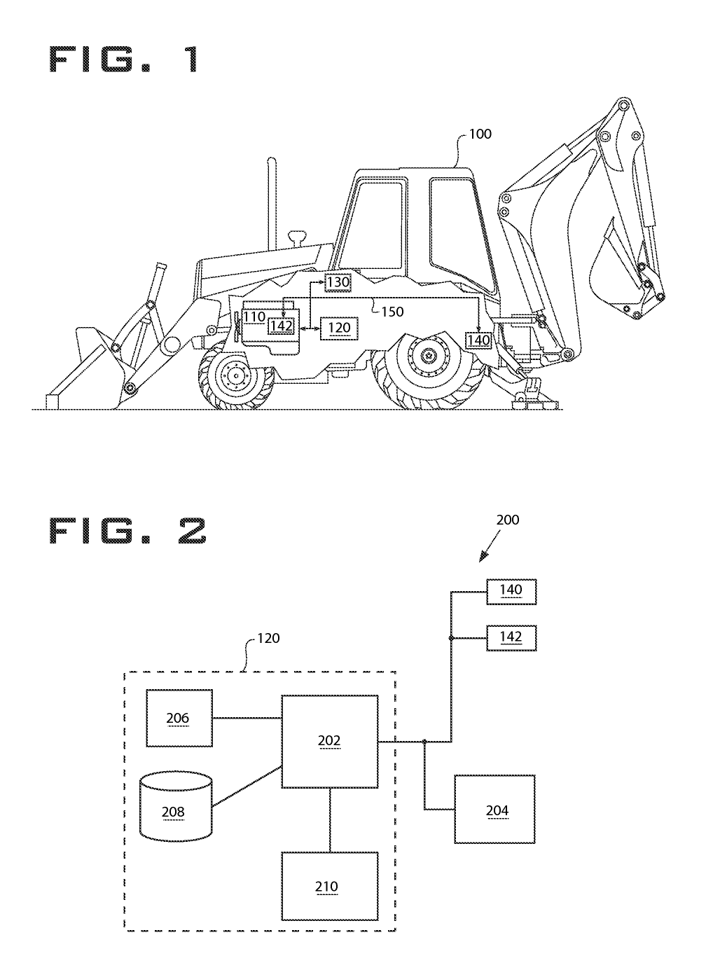

FIG. 2 shows an exemplary control system 200 for detecting sensor failure according to the present disclosure. Control system 200 may include a processor 202, a memory module 204, a network interface 206, a database 208, an operator interface 210, and sensors 140, 142. Other components not shown may be included in control system 200. In addition, certain configurations may not necessarily require all of the components described herein.

Processor 202 may be a general-purpose microprocessor, controller, or digital signal processor. Processor 202 may be a stand-alone processing unit dedicated to sensor failure detection, or a shared resource dedicated to other machine functions. Memory module 204 may include any suitable memory device, including but not limited to: RAM, ROM, flash memory, or other data storage media. Memory module 204 is operably connected to processor 202 for storing information during operation of the control system 200. Database 208 is also operably connected to processor 202, and stores information relating to control system 200. As necessary, this may include one or more of the following: calibration data, data relating to measured parameters of sensors, historical parameter data, statistical information relating to the measured parameters, mathematical models. As with the other components of control system 200, database 208 may be a dedicated storage device or a shared resource for storing information unrelated to sensor failure detection. Likewise, more than one database may be employed as necessary. Database 208 may be composed of any suitable physical data storage device, such as a hard disk or optical drive. Computer memory (for example, RAM or ROM) may also serve the function of database 208.

Processor 202 may be operably connected to operator interface 210 and to network interface 206. Operator interface 210 may be a dashboard, visual screen, and/or audible device through which messages and/or indications may be relayed to the machine operator. Network interface 206 may be a data link to a system off board of the machine, or a connection to other control systems on the machine. For example, processor 202 may communicate with other onboard processors through network interface 206, to relay information and/or to command machine actions (discussed in detail below).

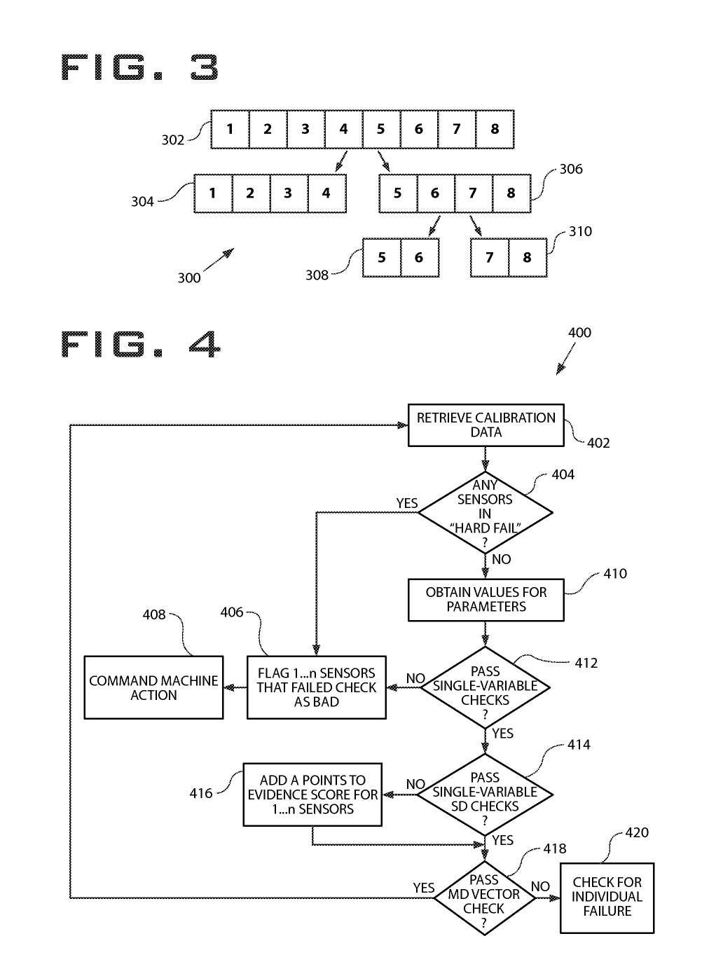

FIG. 3 shows an exemplary set of vectors representing a plurality of sensor parameters. The plurality of sensor parameters includes values obtained from at least one physical sensor onboard the machine, such as physical sensor 140 or physical sensor 142. For example, one of the sensor parameters may relate to a measured temperature or pressure. In order to detect a sensor failure from one of a plurality of sensors on a machine, such as machine 100 in FIG. 1, data from one or more sensors may be aggregated and stored for analysis. Vector 302 in FIG. 3 depicts an exemplary multivariate vector of sensor parameter values that may be analyzed according to methods described herein. In this example, vector 302 stores eight sensor parameter values. The vector of parameter values may be more or less than eight in length; eight is only used for exemplary purposes.

Each numeral “1” through “8” in vector 302 represents a different sensor parameter value. As used herein, a “parameter value” is a numerical value representing data from a particular sensor. A parameter value may be a raw sensor output, such as a voltage (e.g. 6.5V). Alternatively, a parameter value may be a value representing the physical state that a sensor is measuring (e.g., 325 degrees Fahrenheit). A parameter value may alternatively represent a calculated or derived value extrapolated from the sensor data. Additional signal or data processing that may be necessary to turn the sensor signal into a meaningful data value is consistent with the scope of disclosure herein.

Vector 302 may be divided into smaller vectors, containing few parameter values than the original vector. Vector 304 and vector 306 are vectors each representing a subset of parameter values in vector 302. In this example, vector 304 contains the first four parameter values of vector 302, and vector 306 contains the next four parameter values of vector 302. However, vector 302 and vector 304 need not necessarily contain the same number of parameter values, nor necessarily even contain mutually exclusive parameter values. For a vector of length N, a subset of parameter values could be stored in a vector even as large as length N−1.

In addition, a vector such as vector 302 may be divided into more than two other vectors. Likewise, each vector such as vector 306 may be further divided into other vectors, as shown by vector 308 and vector 310. The purpose of this example in FIG. 3 is to depict broadly how a multivariate vector can be divided into any number of subvectors that contain a pertinent subset of the information from the original vector. That construct is useful for describing the methods and systems discussed below.

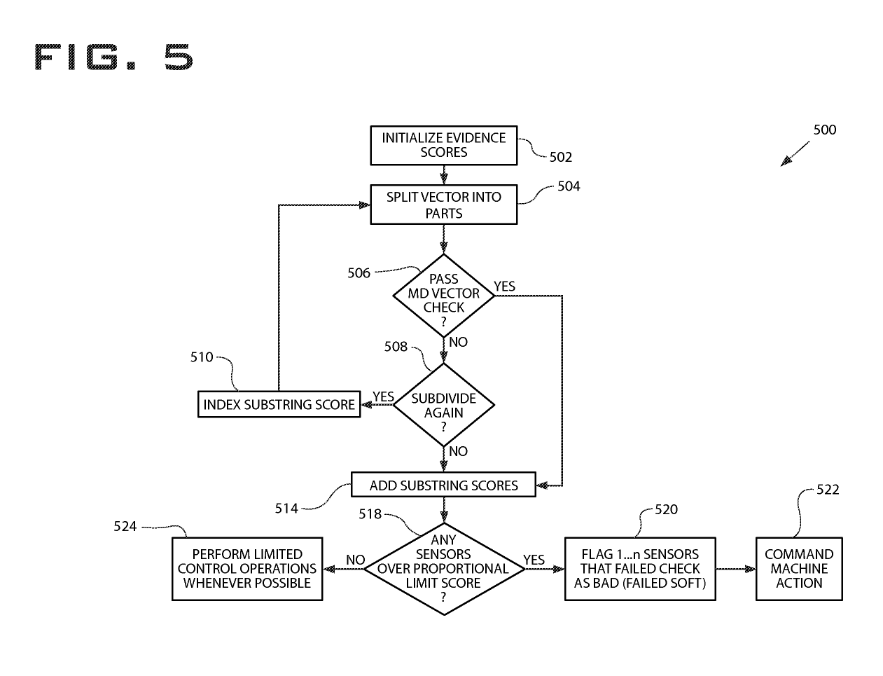

FIG. 4 shows a flowchart of an exemplary method 400 for sensor failure detection in accordance with the disclosure. Method 400 may use physical components such as those described with respect to FIG. 2 to accomplish the steps of the method.

In the first step, step 402, calibration data is retrieved. The calibration data represents a set of data with parameter values for when the system or machine is operating in a “known good” or reference condition, e.g., when systems and components (including sensors) are operating with acceptable ranges. The reference condition can be established by engineering parameters known for the particular design and/or application of the machine. Alternatively, the “known good” condition can be defined by the on-machine observation and measurement during a period externally validated as an acceptable reference. The reference condition may establish the mean, range and variability expected of each individual sensor. Additionally, the reference condition may establish the expected relationships between any combination of sensed parameters in vector 302 or any of its subordinate vectors.

In the next step, step 404, one or more sensors are checked to see if they have “failed hard.” As used herein, a “hard failure” or to “fail hard” means that the sensor has experienced a detectable electrical fault, such as an open circuit, short to ground, an excessive power demand, etc. A hard failure indicates that a sensor may not be providing data values at all, or providing a signal that is otherwise not discernable by a processor as expected. In this step, various electronic measurement thresholds may be employed to ensure that the sensor is in hard failure, such as ensuring that normal electrical system operation has not been detected for at least a threshold number of data points, or for a threshold amount of time.

If it is determined that one or more sensors are in a hard failure mode, the sensors may be identified as failed, step 406. In addition, optionally one or more machine actions may be commanded in response to the identification of one or more failed sensors, step 408. For example, the operator may be alerted to the sensor failure through an indicator at an operator interface, or through a service log or service message. Alternatively (or in addition), the machine might switch to using a different method or mode of operation to compensate for the failed sensor. The machine might switch to an alternative sensor, if one is available. The machine may use a virtual sensor, lookup table, data map, or mathematical model to emulate the expected output of the sensor, if such tools are available. The different mode of operation may also include shutting down or activating one or more subsystems on the machine, employing a different control strategy to control the machine and/or one or more machine components, or restricting modes of operation of the machine. Other machine actions may employed by those of skill in the art as appropriate.

If no hard sensor failures are detected, in the next step, step 410, data values from a plurality of sensors are obtained. In the next step, step 412, the system may perform an analysis on some or all of the data values obtained in step 410. Step 412 determines if the sensor is providing data values that are not within the expected range of values for the sensor. For example, if an airflow sensor is designed to provide a value between 5 and 15V to indicate the speed of air through a component, and the sensor is indicating a value of 2V or 20V, the method may determine that this sensor fails as a single variable check. Like step 404, appropriate actions can be taken as described previously with relation to step 408 and as employed by those of skill in the art. In addition, step 412 may alternatively be combined with step 410, and the single variable check may be termed a “hard failure” as well.

If the single-variable checks are passed, the next step, step 414, checks the standard deviation of the individual data values observed over an appropriate period of time. In this step, the control system may check the standard deviation of one or more of the parameter values obtained in step 410. If the standard deviation of a series of observations is at and/or above a threshold established previously as a reference condition, then points may be added to an “evidence score” for that particular sensor, step 416. Multiple different thresholds may also be set, to add a different number of points to an evidence score depending upon how far the particular data point deviates from its reference variability. As used herein, an “evidence score” is an indicator of the probability that a particular sensor has failed. An evidence score is preferably but not necessarily a numerical value. For example, an evidence score may be an integer wherein a higher number indicates a higher probability that the sensor has failed. A threshold value may be set such that if the evidence score for a particular sensor is above the threshold, the control system declares that the sensor has failed, as in step 406. It should be noted that when using the term “exceeds” or “exceeded,” this term usually denotes when a number is greater than another number, such as if the evidence score for an input parameter is above (e.g., “exceeds”) a threshold. However, as used herein, “exceeds” or “exceeded” may also refer to configurations where the evidence score is decreased, and a lower score indicates a higher probability that the sensor has failed. In that configuration, if the evidence score “exceeds” the threshold in terms of absolute value, this may indicate that the sensor has failed. Put another way, whether one chooses to increment or decrement an evidence score, and use positive or negative numbers, is wholly immaterial to the scope of the present disclosure. Both configurations may be successfully used consistent with the present disclosure.

If the standard deviation checks in step 414 are passed, the system proceeds to step 418, to calculate the Mahalanobis distance of the vector of parameter values. Mahalanobis distance, as used herein, refers to a mathematical representation used to measure data profiles based on correlations between parameters in a data set. Mahalanobis distance differs from Euclidean distance in that Mahalanobis distance takes into account the correlations of the data set. Mahalanobis distance of a data set X (e.g., a multivariate vector) may be represented as

MDᵢ=(Xᵢ−μₓ)Σ⁻¹(Xᵢ−μₓ)′

where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance.

If the calculated Mahalanobis distance is above a threshold amount, then the MD vector check fails, and the system proceeds to step 420, to check for failure of an individual sensor. Otherwise the system may proceed to the beginning step to check again for failure at another time.

It should be noted that embodiments of the disclosure may be performed with steps additional to those described in FIG. 4. Conversely, not all steps described in FIG. 4 must be performed in all embodiments. In addition, the order of the steps may be re-arranged in different embodiments. For example, step 410, obtaining data values for measured parameters, may be performed before step 404 and/or or simultaneously with step 404. Likewise, the order of steps 404, 412, 414, and 418 may be re-arranged and/or performed simultaneously in some embodiments. In addition, step 402 may be performed only once during employment of method 400, or may be performed more than once, retrieving calibration data as needed through various iterations of method 400.

FIG. 5 shows an exemplary method 500 to check for the failure of an individual sensor. Method 500 is employed because when the Mahalanobis distance is calculated for multiple parameters, and the calculated MD is above a threshold amount, it is not known, based on the MD alone, which particular parameter value(s) caused the MD value to be above a threshold (i.e., which particular sensor value may be suspected of failing soft).

In the first step, step 502, “evidence score” counters are initialized for each parameter value. In the next step, step 504, a vector of parameter values is split into a plurality of smaller vectors (or “substrings” or “substring vectors”). For purposes of example we can refer again to vector 302 in FIG. 3. In FIG. 5, vector 302 has eight different parameters. Vector 304 represents a subset of vector 302, with the first four values of vector 302, and vector 306 also represents a subset of vector 302, with the remaining four values of vector 302. Preferably, the vector splitting process can be predetermined to maximize sensitivity to one or more sensors that frequently fail soft in normal use. Alternative the action of step 504 can be recursive in nature, with multiple passes through the process of FIG. 5 when required and when there are sufficient available computing resources to do so.

In the next step, step 506, the Mahalanobis distance is calculated for one of the substring vectors (e.g., vector 304). If the calculated Mahalanobis distance is below a threshold amount for the substring vector then no value is added to that substring's evidence score.

If the Mahalanobis distance is above a threshold amount, then the evidence scores for the parameters contained in the vector are incremented, and the vector may optionally be split into parts again, leading to another series of Mahalanobis distance checks. For example, if vector 306 does not pass an MD test, then the vector 306 may be split into parts and the MD checked on each of the substrings of vector 306 (e.g., vectors 308 and 310). Alternatively, either vector 308 or vector 310 may be evaluated without requirement to inspect the other substring. This process may repeat until the MD is checked on all substring vectors, or all preferred substring vectors, and the vectors which fail are split into substring vectors to check the MD of those substrings. In other words, steps 504, 506, 508 and 514 may optionally be performed recursively. In this option, each time that a Mahalanobis distances is calculated for a vector and the result is above a threshold amount, the evidence score is incremented for each parameter contained in the vector. Then, the vector is split into parts and a Mahalanobis distance is calculated for each of the substring vectors. For each substring vector that also returns an MD value above a threshold amount, the process is repeated until either a substring vector does not return a high MD value, or the vector is sufficiently small such that no further calculations are necessary or the MD calculation is not possible (i.e., if the vector length is one, then an MD check is not possible, and the calculation reduces to a simple standard deviation check).

In step 518, after the evidence scores are compiled for each parameter value in the original vector, if the evidence score for one or more parameters is above a proportional limit, then the sensor corresponding to that parameter value is flagged as having failed soft, step 520. As used herein, a “proportional limit” is a comparison of the evidence score of a parameter to the evidence score of one or more other parameters. If the evidence score of one of the parameters is significantly higher (for example, an order of magnitude or more higher) than other evidence scores, then the evidence score may be said to be above a proportional limit.

In this case, another machine action may be commanded, step 522. Examples of machine actions that may be commanded in step 522, in response to the soft failure of a sensor include, but are not limited to: disabling the machine, switching the machine into a different mode of operation, disabling the sensor, disabling a subsystem on the machine, communicating a message to the machine operator or other communication system, creating or modifying a service indictor message or signal, de-rating an engine, switching to a different control system or control system profile, employing a virtual sensor to replace data input from the physical sensor. Additionally any actions appropriate for a sensor experiencing a hard failure can be applied to a sensor with a soft failure, as known to those of skill in the art.

In step 524, perform limited control operations whenever possible, when a process flow leads to step 524, there is insufficient evidence to isolate a specific sensor experiencing a soft failure, however it is then clear that the controls system is not functioning as intended. Step 524 may enable a different set of compensating control actions than step 522, such as limiting operations of the system only under certain conditions while preserving normal operation in others. This enables a proportionate response to the level of knowledge the system has about its own functionality, rather than an “all or nothing” diagnostic strategy common to most current processes.

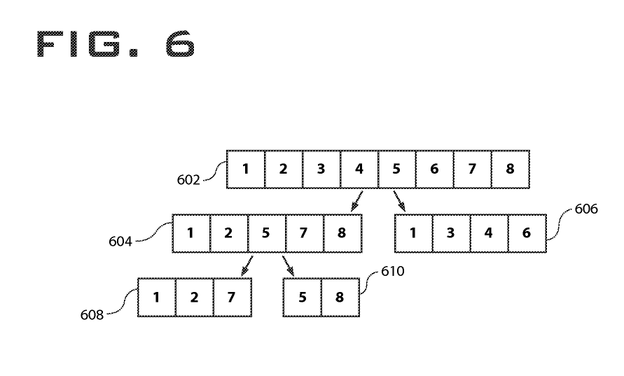

FIG. 6 shows an exemplary set of vectors representing a plurality of sensor parameter values. This example again shows that a vector such as vector 602 may be split into sub-vectors which are of varying length and which may not necessarily contain mutually exclusive data. For example, both vector 604 and vector 606 contain parameter values corresponding to sensor “1” on the machine. Splitting a vector such as vector 602 in this fashion may be advantageous where there is reason to believe that one or more particular sensors are more likely to fail soft than other sensors, and therefore warrant closer scrutiny when a potential soft failure is suspected.

For example, the sensor represented by the numeral “1” in vector 602 might be a sensor that is more likely to fail soft as a mode of failure than the other sensors represented in vector 602. Perhaps the other sensors in vector 602 are statistically more likely (based upon past knowledge or experience) to fail hard rather than to fail soft. In this case, the methods described in FIGS. 4 and 5 may be carried out, however, the steps of the method may take into account this past experience or system knowledge. If sensor “1” is more likely to fail soft, then the method of FIG. 5 may split the original vectors into sub-vectors which contain the parameter value for sensor “1”, and run an MD check on these sub-vectors first. If the evidence score against sensor “1” quickly rises, then the proportional limit score will rise and the system may detect the soft failure of sensor “1” more quickly than if the system split the vector 602 into sub-vectors without pre-suspecting that any one particular sensor had failed soft.

### INDUSTRIAL APPLICABILITY

The present disclosure provides advantageous systems and methods for detecting the failure of one or more sensors associated with a machine. The disclosed technology may be advantageously used in a number of different machines, from stationary machines such as power generation equipment to mobile machines such as earth-moving machines. The methods and systems disclosed herein provide for an efficient way to detect the failure of a sensor even when the sensor is outputting data that is theoretically within the bounds of expected data. Further, the methods and systems disclosed herein offer a robust way to detect sensor failure while minimizing the amount of data storage and computational power that must be devoted to sensor failure detection.

The disclosed systems and methods may be employed to ensure the reliability of control systems on a machine, so that a machine does not perform less efficiently or fail when a sensor fails. In addition, efficient detection of sensor failure may ensure longer operational life for the machine, less machine downtime, and/or minimal cost operation. This in turn may increase the overall operational efficiency of the machine as well as return on investment related to the machine.

Other embodiments, features, aspects, and principles of the disclosed examples will be apparent to those skilled in the art and may be implemented in various environments and systems.

What is claimed is:

M1. A method of controlling a machine, comprising:
retrieving calibration data associated with a plurality of input parameters,
wherein at least one of the plurality of input parameters represents data from a physical sensor on a machine
obtaining a set of values of the plurality of input parameters;
calculating a Mahalanobis distance of a set of values of the input parameters based on the calibration data;
incrementing an evidence score of an input parameter if the Mahalanobis distance exceeds a distance threshold; and
commanding a machine action when the evidence score of an input parameter exceeds an evidence score threshold.

M2. The method of claim M1, including the step of:
calculating a standard deviation of at least one of the plurality of input parameters and incrementing the evidence score of an input parameter.

M3. The method of claim M1, including the step of:
calculating whether at least one of the plurality of input parameters falls within a predetermined range of values.

M4. The method of claim M1, wherein the machine action includes providing an indication that one of the plurality of physical sensors has failed.

M5. The method of claim M4, wherein the indication includes an indication that the mode of sensor failure was a soft failure.

M6. The method of claim M1, including the step of:
calculating a Mahalanobis distance of a subset the set of values of the input parameters based on the calibration data and incrementing the evidence score of an input parameter.

M7. The method of claim M1, wherein the evidence score is an integer.

M8. The method of claim M1, wherein the step of commanding a machine action includes causing a machine control system to use a virtual sensor in place of at least one of the plurality of physical sensors.

M9. The method of claim M1, wherein the step of commanding a machine action includes removing power to the machine.

M10. The method of claim M1, wherein the step of commanding a machine action includes deactivating a machine subsystem.

S1. A system for detecting sensor failure on a machine, the system comprising:
a plurality of physical sensors;
an electronic control module operably connected to the plurality of physical sensors and a data storage unit, and configured to:
retrieve reference calibration data associated with a plurality of input parameters,
wherein at least one of the plurality of input parameters represents data from at least one of the plurality of physical sensors;
obtain a set of values of the plurality of input parameters; calculate a Mahalanobis distance of the set of values of the input parameters to the reference calibration data;
increment an evidence score of an input parameter if the Mahalanobis distance exceeds a threshold distance value; and
command a machine action when the evidence score of an input parameter exceeds an threshold evidence score value.

S2. The system of claim S1, wherein the electronic control module is further configured to calculate the standard deviation of at least one value of the plurality of physical sensors.

S3. The system of claim S1, wherein the machine action includes causing a machine control system to use a virtual sensor in place of at least one of the plurality of physical sensors.

S4. The system of claim S1, wherein the machine action includes providing an indication of a sensor failure.

S5. The system of claim S1, wherein the machine action includes removing power to the machine.

S6. The system of claim S1, wherein the machine action includes deactivating a machine subsystem.

S7. The system of claim S1, wherein the electronic control module is further configured to send data relating to at least one of the plurality of physical sensors off-board the machine.

S8. The system of claim S1, wherein the electronic control module is further configured to calculate a Mahalanobis distance of a subset of the set of values of the input parameters based on the calibration data.
